(19) United States
(12) Patent Application Publication
(10) Pub. No.: US 2002/0177446 A1
(43) Pub. Date: Nov. 28, 2002

(54) System and method for providing variable transmission bandwidth over communications channels

(76) Inventors: Alex Bugeja, Acton, MA (US); Anant Agarwal, Weston, MA (US)

Correspondence Address: DALY, CROWLEY & MOFFORD, LLP, SUITE 101, 275 TURNPIKE STREET, CANTON, MA, 02021-2310, US

(21) Appl. No.: 10/154,367

(22) Filed: May 23, 2002

Related U.S. Application Data
(60) Provisional application No. 60/293,060, filed on May 23, 2001.

(51) Int. Cl. H04Q 7/20

(52) U.S. Cl. 455/450; 455/67.1; 455/522

(57) ABSTRACT

A system and method are provided for variably adjusting transmission bandwidth over communications channels such as wireless local area networks (WLAN5) and wired channels such as cable lines. The system includes a programmable high speed data converter provided as part of a programmable front end interfacing to a communications channel. A controller coupled to the programmable front end analyzes a frequency spectrum to determine a required bandwidth for transmission of data and adjusts system filter characteristics to avoid unused portions of a spectrum thereby allowing the system to use less power than would otherwise be used if the system used the entire available spectrum.

### RELATED APPLICATIONS

This application claims the benefit of U.S. Provisional Application No. 60/293,060 filed May 23, 2001 which application is hereby incorporated herein by reference in its entirety.

### GOVERNMENT RIGHTS

Not applicable.

### FIELD OF THE INVENTION

This invention relates to transmission systems and more particularly to a method and apparatus for providing improved transmission capability over communications channels.

### BACKGROUND OF THE INVENTION

As is known in the art, a communications system includes two or more terminals between which information can be transferred over a communications channel. The terminals or nodes may include electrical apparatus such as computer implemented switches and processors, optical apparatus or any other apparatus appropriate to process the resource being provided to the terminal.

As is also known, a communications channel or more simply a “channel” refers to a combination of equipment and transmission media capable of receiving a signal at a first point (e.g. a source node) and delivering it to a second point (e.g. a destination node) which is typically remote from the first point. The term channel typically refers to the smallest subdivision of a transmission system. That is, one channel is capable of carrying only one information stream (e.g. voice or data) from the source node to the destination node. Although in the strictest sense of the term, a channel signifies a one-way path (providing transmission capability in only one direction) it sometimes also represents a two-way path, providing transmission in both directions.

A channel may be a physical wire or link or contain optical or radio links. The channel may be a dedicated wire or part of a switched, multiplexed packet network. A channel may occupy all or only part of the available bandwidth of the transmission medium. A channel is also sometimes referred to as a circuit, facility, link, line or path.

As is also known in the art, the transmit/receive bandwidth of a channel between a source and a destination is one factor which determines the amount of power consumed by a communications system. Thus, during those times in which a communications system cannot or does not utilize the entire available system bandwidth, more power is consumed than necessary.

It would, therefore, be desirable to provide a technique to reduce transmit/receive power consumption in a communications system.

### SUMMARY OF THE INVENTION

In accordance with the present invention, a method for providing a variable bandwidth communications channel includes analyzing a frequency spectrum of a transmission band to determine a transmission bandwidth required for data and providing a spectrum for transmission of the required data within the transmission band and which allows a reduction in the amount of power consumed by a communications system.

With this particular arrangement, a technique for providing a variable bandwidth transmission channel in a communications system while taking into account power consumption is provided. By first determining the bandwidth required for transmission, filter and power consumption characteristics of a front end of a communications system can be adjusted such that transmission of required data within a given transmission band takes place over a bandwidth which is both power and spectrally efficient. In one embodiment, the frequency spectrum is analyzed by examining, via a configurable converter, multiple bandwidths at multiple resolutions.

In accordance with a further aspect of the present invention, a system for providing a spectrally and power efficient communication channel includes a filter bank and a data converter coupled to a controller which provides one or more control signals which adjust or set operating characteristics of one or more of the filter bank and the data converter.

With this particular arrangement, an efficient data transmission system is provided. The controller analyzes a frequency spectrum to determine a transmission bandwidth required for data transmission. The controller then provides one or more control signals which adjust or set the operating characteristics of one or more of the filter bank and the data converter to reduce transmit/receive power consumption of the communications system to a level which is below the power consumption level which would exist if the communications system utilized the entire communication channel bandwidth while still accommodating bandwidth required to transmit and receive data. In one embodiment, the control signals also allow the communications system to provide a spectrally efficient transmission bandwidth available over a channel to an application end user. In one embodiment, the filter bank and the data converter are coupled to a radio frequency (RF) front end to provide an RF automated front end (AFE) and the controller provides one or more control signals which adjust or set the operating characteristics of one or more of the RF front end, the filter bank and the data converter such that the system is provided having a reduced power consumption characteristic and an overall filter characteristic which can be changed depending upon, inter alia, channel usage within a band and the existence of one or more interferer signals. The system power consumption and filter characteristics can be changed by changing the power consumption and/or filter characteristics of a single component within the system or the system power consumption and filter characteristics can be changed in a distributed fashion by changing the power consumption and filter characteristics of multiple components within the system. In either approach, varying transmission bandwidth over communications channels results in a use of system power and bandwidth which is relatively efficient regardless of the conditions compared with power consumption and bandwidth efficiency provided by prior art systems.

### BRIEF DESCRIPTION OF THE DRAWINGS

The foregoing features of the invention, as well as the invention itself may be more fully understood from the following detailed description of the drawings, in which:

FIG. 1 is a block diagram of a communications system including a bi-directional radio frequency/analog from end (RF/AFE);

FIG. 2 is a block diagram of a plurality of terminals communicating with an access point;

FIGS. 3-3B are a series of plots illustrating the addition of a second channel within a communications band;

FIGS. 4-4C are a series of plots illustrating the re-configuration of a channel to reduce system power consumption and avoid an interfering signal;

FIGS. 5-5B are a series of plots illustrating the use of channel bandwidth;

FIG. 6 is a block diagram of a processing system;

FIG. 6A is a block diagram of a processing system;

FIG. 7 is a block diagram of a system in which layers can immediately be combined; and

FIG. 7A is a block diagram of a system in which layers higher than the layers shown in FIG. 7 can be combined.

### DESCRIPTION OF THE PREFERRED EMBODIMENTS

Before describing the details of the present invention, some introductory concepts and terminology are explained. In general overview, the present invention relates to a technique and apparatus for optimally providing transmission bandwidth over communications channels such as wireless local area networks (WLANs) and wired channels such as cable lines. The technique and apparatus utilize a programmable high speed data converter provided as part of a radio frequency (RF) analog front end (AFE) interfacing to a communications channel. A controller provided in a digital backend of the system provides control signals to change one or more operating characteristics of one or more components of the RF/AFE including but not limited to the data converter to realize optimal provision of a maximum transmission bandwidth available over the channel at any one time to the application end-user.

Reference is sometimes made herein to a “frequency spectrum” or more simply a “spectrum.” The term “spectrum” refers to a portion of or the entire electromagnetic frequency range. Portions of the electromagnetic frequency range are made available for a particular service and are often referred to as a “band.” For example, a continuous frequency range from 88 to 108 megahertz (MHz) is allocated for FM radio broadcast and is referred to as the FM radio band. Similarly, the continuous frequency range from 825 to 890 MHz is allocated for cellular telephone transmissions and is referred to as the FM radio band. Similarly still, the Instrumentation, Scientific and Medical (ISM) Band is an unlicensed publicly owned part of the radio spectrum in the 900 MHz, 2.4 GHz and 5 GHz ranges.

Reference is sometimes made herein to operations which take place within or with respect to a particular frequency band or with respect to a particular transmission protocol. Those of ordinary skill in the art should also appreciate that references herein to particular bands or protocols is intended to be illustrative and to provide clarity in the description and is not intended to limit the scope of the invention.

Reference is also made herein to “extents of spectrum” or more simply an “extent.” As used herein, the term extent refers to a section or portion of a frequency range and may correspond to a portion of one or more frequency bands. An extent may correspond to a range of frequencies of, or within a frequency band or across multiple frequency bands. Multiple extents can exist within a frequency spectrum and within a frequency band.

Reference is also sometimes made herein to an “interference source” or more simply an “interferer.” The term “interferer” refers to any method or apparatus which inhibits or degrades communication within one or more frequency bands. An interferer can correspond, for example, to uncoordinated communications between users. Non-communication sources such as microwave ovens and the like can also act as interferers. Alternatively still, an interferer can be provided from a combination of uncoordinated communication and non-communication sources.

Also, it should be appreciated that, in an effort to promote clarity, reference is sometimes made herein to “signals” or “data” being transmitted between “nodes” or “terminals” of a “wired” or “wireless” communications system. Such references should not be taken as limiting the scope of the present invention to use in any particular type of communications system. Rather, the present invention finds application in a wide variety of different network types including but not limited to communications networks, wireless networks, data networks and other types of networks which utilize a wide variety of different types of network nodes including but not limited to multiple access techniques such as TDMA, FDMA, DCMA and OFDMA.

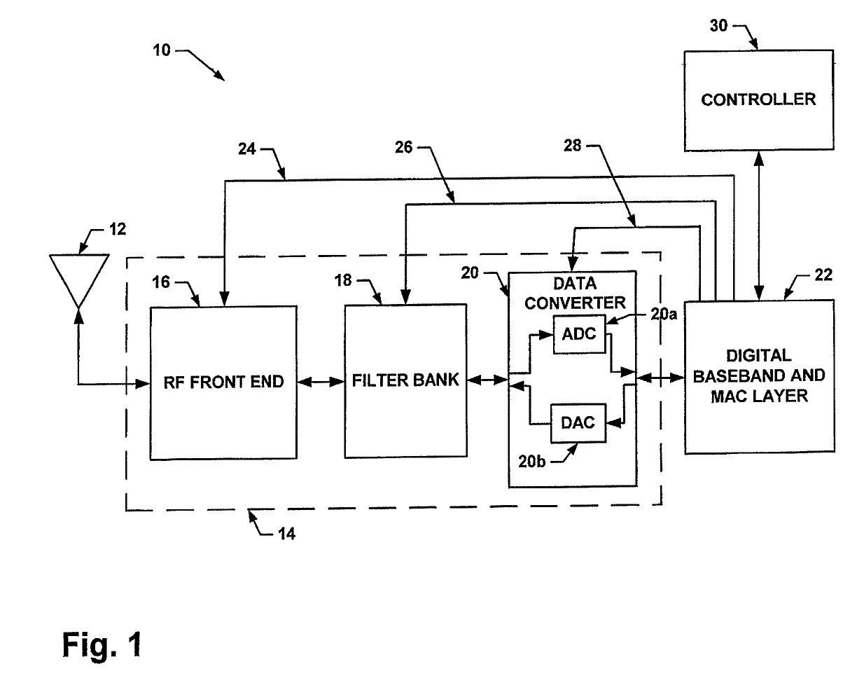

Referring now to FIG. 1, a system 10 includes an antenna 12 having a radio frequency (RF) analog front end (AFE) 14 coupled thereto (hereinafter RD/AFE 14). It should be appreciated that the system 10 is bi-directional in nature, and thus handles both transmission as well as reception of data.

The RF/AFE 14 includes an RF front end 16, a filter bank 18 and a wide-band, high-speed, high-resolution data converter bank 20. In one embodiment, the filter bank 18 includes at least one filter segment having a low pass filter characteristic. The filter bandwidth of at least one filter segment in the filter bank 10 is programmable to obtain a preferred, and in some cases, a maximum power efficiency in the wide-band, high-speed, high-resolution data converter bank 20 coupled to the filter bank 18. The data converter 20 is described in a co-pending patent application No. ______, entitled “Programmable Power-Efficient Front End For Wired and Wireless Communication” and filed on Apr. 30, 2002, which application is assigned to the assignee of the present invention and is incorporated herein by reference in its entirety. In general overview, the data converter bank 20 includes an analog-to-digital converter (ADC) 20a for use in a receive path in which signals propagate from the antenna 12 toward the data converter bank 18. The data converter bank 18 also includes a digital-to-analog converter (DAC) 20b for use in a transmit path in which signals propagate from the data converter bank 18 toward the antenna 12.

The data converter bank 20 is coupled to digital baseband and media access control (MAC) layers 22 and sends and receives baseband data from the digital baseband layer as well as higher digital MAC layers 24.

It should be noted that the preferred embodiment of the system 10 shown in FIG. 1 for realizing spectrally efficient communication illustrates the case in which communication takes place over a wireless channel. After reading the present description, however, those of ordinary skill in the art will appreciate and understand, how to modify system 10 for operation in the case of wired channels in which case it would be possible to omit the antenna 12 and possibly the RF front end 16.

A controller 28 (which in one embodiment is implemented in software) controls operation of the system 10. The controller 28 controls several aspects of the MAC layer itself, operation of the digital baseband, and several parameters relating to operation of the RF and analog front end 14 (RF/AFE), thereby enabling increased (and in some cases possibly optimal) bandwidth to an application running at higher levels (not shown in FIG. 1).

Some parameters controlled by techniques which maybe implemented in the controller include: (1) frequency synthesizer center frequency (frequency synthesizer not shown in the RF front end of FIG. 1); (2) filter bandwidth control; (3) data converter bandwidth control; (4) data converter resolution control; and (5) bias currents/power consumption. Frequency synthesizer center frequency control signals are generated by the controller 28 and provided to the RF front end 16 over signal path 24 via digital baseband and MAC layer 22. Filter bandwidth control signals are provided to filter bank 18 over signal path 26 via digital baseband and MAC layer 22 and data converter bandwidth control signals and resolution control signals are provided to data converter 20 over signal path 28 via digital baseband and MAC layer 22.

It should be appreciated that FIG. 1 is intended to be representative of a generic RF/AFE in terms of architecture. In practice, the filtering function is generally spread throughout the RF/AFE 14 and, as is known, typically includes bandpass filtering in the RF front end segment 16 prior to the filter bank 18. Optionally, and as needed to meet specifications for particular protocols, additional programmability (typically coarser) may be introduced into the bandpass filtering in the RF segment 16 to reject interferers as early as possible and allow maximum amplification and hence dynamic range prior to data conversion in the receive path.

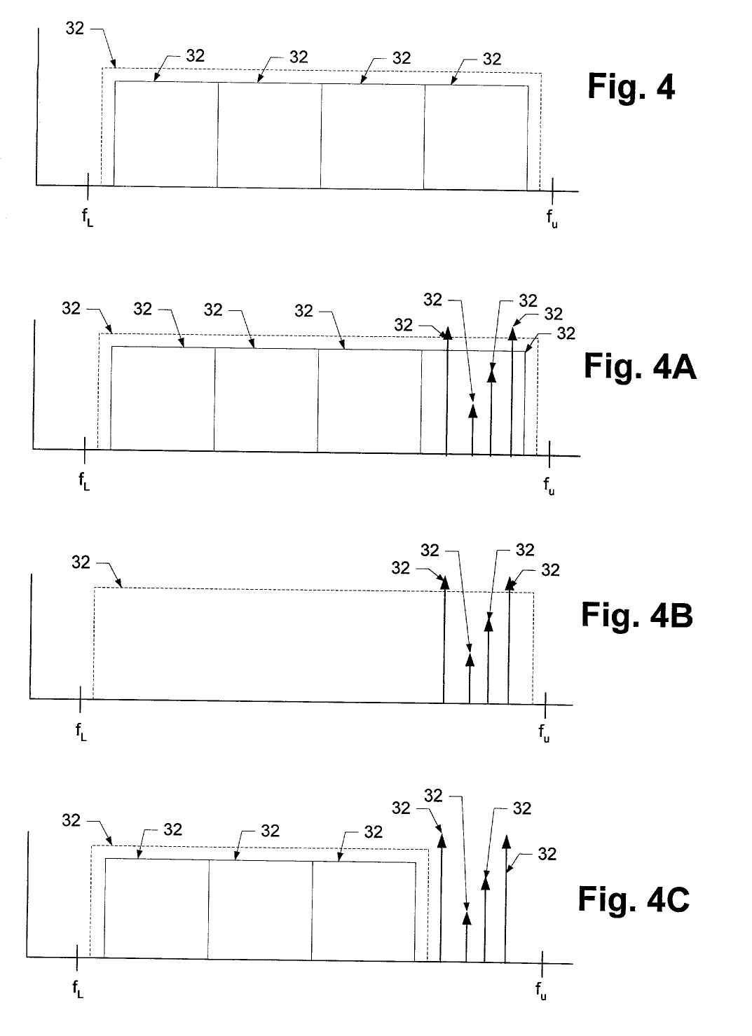

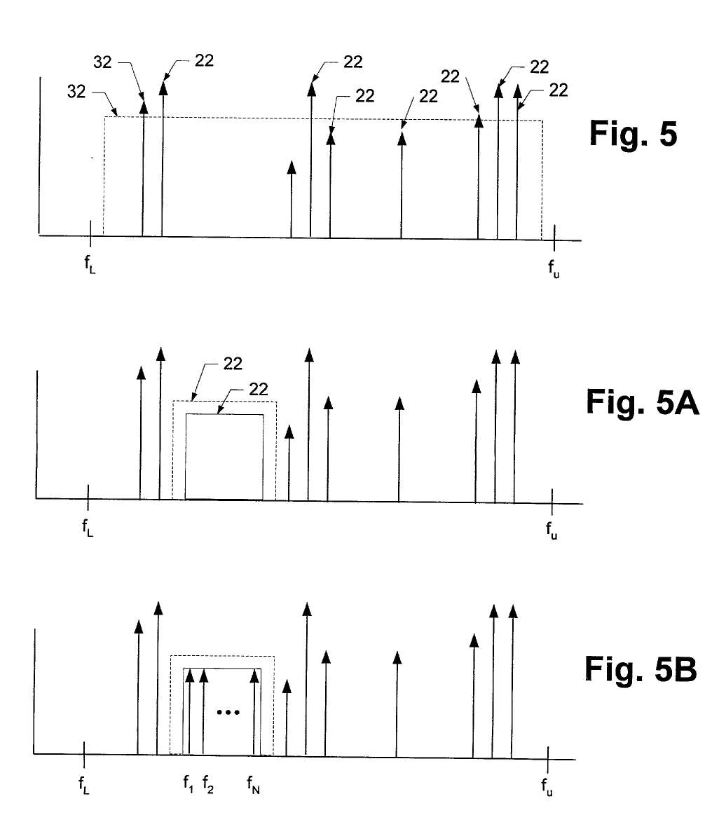

By controlling the operating characteristics of one or more of the RF front end 16, the filter bank 18 and the data converter 20, via the controller 28, the overall operating characteristics of the system 10 can be changed. Thus, by providing the programmable high speed data converter 20 as part of an RF/AFE interfacing to a communications channel and controlling the operating characteristics of one or more of the individual components which provide the RF/AFE, a system which realizes optimal provision of a maximum transmission bandwidth available over a channel at any one time to an application end-user is provided. The manner in which the operating characteristics of one or more of the individual components which provide the RF/AFE 14 can be changed will become apparent from the description provided below in conjunction with FIGS. 4-5B.

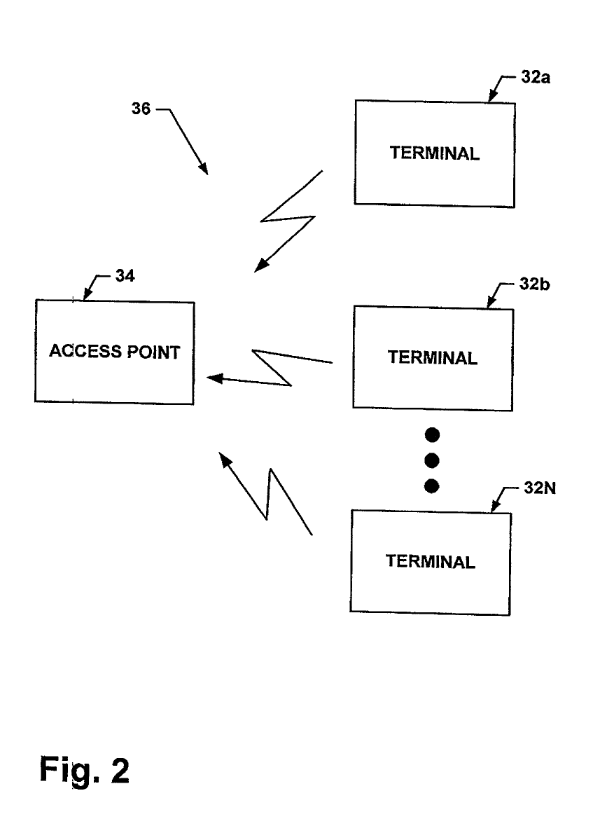

Referring now to FIG. 2, a plurality of mobile users 32a-32N generally denoted 32, enabled with a preferred embodiment of the system communicate with an access point 34 over wireless channels 36. Access point 34 may be provided, for example as a gateway to a wired network such as an Ethernet LAN. Two parameters of note in such an environment are the channel bandwidth available and the protocol bandwidth of a particular protocol used for transmission and reception.

For example, bandwidth of a commonly used unlicensed channel in the United States is 80 MHz for the 2.4 gigahertz (GHz) unlicensed industrial, scientific, medical (ISM) band. The protocol bandwidth of a common protocol used in this band is 22 MHz for the IEEE 802.11b protocol. Generally, access points such as access point 34, are set up so as to be able to communicate with multiple users simultaneously (e.g. terminals 32). Access points having relatively high performance characteristics typically operate over different portions of the band to make available the entire protocol bandwidth to each user. Such access points are assumed here and the preferred embodiment of the system is assumed to be installed in the mobile terminals 32, although those of ordinary skill in the art will also recognize that the same system could equally be installed in the access point 34 rather than in the mobile terminals.

In a preferred embodiment the frond end utilizes relatively high speed data converters capable of digitizing and synthesizing bandwidths equivalent to the entire available band. This makes available to the users a maximum of Protocol bandwidths which may be computed as:

Channel B/W=n×(Protocol B/W)

in which:

n is the number of protocol bandwidths which fit inside the band, rounded down to the nearest integer.

For example, in a system in which the protocol in IEEE 802.11b is used (i.e. protocol B/W—22 MHz) and the band is 2.4 Ghz ISM (i.e. channel B/W=80 MGz) then n equals 3. The controller 28 (FIG. 1) is responsible for using the capacity to make available to the user as high a bit rate as possible subject to power constraints and thus controller 28 controls the converter 20 and the rest of the RF/AFE 14.

It should be appreciated that most of the time, less than the maximum number of users are accessing a single access point. For boosting transmission speed. prior art systems cannot take advantage of the resources available due to the fact that less than the maximum number of users are accessing a single access point. Thus one advantage of this system over prior art systems is that prior art systems cannot make use of unused band capacity.

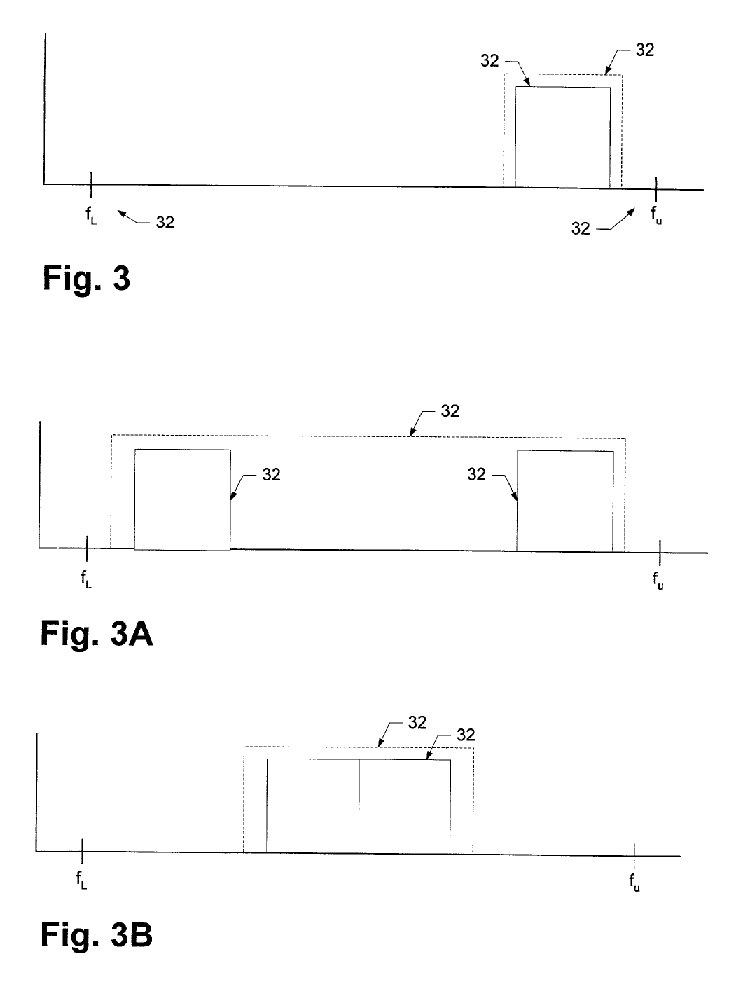

Referring now to FIGS. 3-3B in which like elements are provided having like reference designations throughout the several views, a series of plots are shown which illustrate the basic operation of a system (e.g. system 10 described above in conjunction with FIG. 1), operating in accordance with the present invention. This mode of operation is sometimes referred to herein as “bandwidth-on-demand.” The plots each include a horizontal axis corresponding to frequency and a vertical axis corresponding to magnitude.

In the FIGS. 3-3B, a lower bound of an available frequency band 39 is denoted as f_{L} and designated with reference character 40 and an upper bound of the available frequency band is denoted as fu and designated with reference character 42. In the 2.4 GHz ISM band, for example, the lower bound f_{L} would correspond to approximately 2.4 GHz and the upper bound f_{U} would correspond to approximately 2.48 GHz. Thus the total available band ranges from f_{L} to f_{U}.

Referring now to FIG. 3, a prior art technique is shown in which a bandwidth 44 within the overall band is associated with a single user transmitting over a single protocol. In this technique, the RF/AFE 14 (FIG. 1) provides an overall filter characteristic represented as a filter skirt 46 around the protocol bandwidth 44. The RF/AFE filtering may be provided in a distributed fashion as discussed above in conjunction with FIG. 1.

Referring now to FIG. 3A, in accordance with a first embodiment of the present invention a technique in which multiple protocol bandwidths 48, 50 are randomly allocated is shown. In this example, the first and second bandwidths 48, 50 respectively are encompassed by an appropriate filter skirt 52 provided by a filter having an appropriately programmed filter function. In this case, the data converter bank (e.g. data converter bank 20) is programmed to have a bandwidth equal to the bandwidth encompassed within the filter skirt 52, and the frequency synthesizer center frequency is set to the center of this filter skirt 52. Thus, the system of the present invention provides a communications channel having a variable bandwidth.

While this approach makes available multiple protocol bandwidths as desired, it is inefficient in terms of power consumption, owing to the need to digitize and synthesize unused portions of the band (e.g. portion 53) between the protocol bandwidths 48, 50.

Referring now to FIG. 3B, a second embodiment in which an RF front end (e.g. the RF front end 14 of FIG. 1) is programmed, so as to lump protocol bandwidths 54, 56 as tightly together as possible (dictated by the limits set in the protocol specifications) and thus conserve power. The frequency synthesizer center frequency and the filter skirts 58 are set so that the bandwidth operated on by the data converters (e.g. the data converts 20 of FIG. 1), is thus reduced in proportion to the reduction in unused bandwidth, thereby also providing a proportionate reduction in power consumption by the communications system.

For example, in a zero-IF implementation, the digitized band would exist within the filter skirt 58 but would be transferred to zero frequency, thereby providing power savings when used with data converters capable of reducing power with an operating bandwidth.

The choice of which individual protocol bandwidths on which to transmit throughout the available band may be made at the beginning of a transmission in several ways. For example, one embodiment transmits on several trial bands and monitors bit error rate (BER) in each band. Another embodiment digitizes the entire band first using a wideband ADC (e.g. ACD 20a described above in conjunction with FIG. 1) and decide where the RF energy in the channel is lowest. The latter method is generally faster.

Referring now to FIGS. 4-4C, in which like elements are provided having like reference designations throughout the several views, in one particular embodiment a system controller implements techniques for selecting protocol bandwidths on which to transmit throughout the overall band. This particular embodiment reduces power consumption and also is capable of handling interferers on an ongoing basis throughout the life of a session.

Referring first to FIG. 4, in one exemplary embodiment, four extents 74-80 within which a single user can transmit signals is shown in a band for example, correspond to four protocol bandwidths. It should be appreciated that while in this particular example, four extents 74-80 are shown, those of ordinary skill in the art will appreciate that in other embodiments, fewer or more than four extents 74-80 can exist within the overall band 70. The extents may, for example, correspond to four protocol bandwidths.

Referring now to FIG. 4A, band 80 becomes unusable. This may, for example, be the result of one or more interfering signal sources (not shown) producing interfering signals 84 in the band 80. It should be appreciated that although the example shown in FIG. 4A illustrates the interfering signals 84 present in band 80, in other cases, interfering signals or other impediments to band usage can be present in one or more of the bands 74-80. The interfering signals may, for example, result from uncoordinated communications between other users, or from non-communication sources such as microwave ovens and the like, or from a combination of uncoordinated communications and non-communication sources. Interfering signals 84 are capable of corrupting a particular band in which they occur (for example, band 80 in FIG. 4A) and can also potentially degrade all communication bands 74-80 by saturating components in an RF/AFE (e.g. RF/AFE 14 of FIG. 1). It will be appreciated that saturation of the RF/AFE reduces dynamic range, resulting in degradation of bit error rate (BER) of an entire communication session. Thus, it is typically very undesirable to have interfering signals within a band of interest.

Referring now to FIG. 4B, in one particular embodiment, the system detects the presence of the interfering signals or other band usage impediment 84 by continually monitoring the BER for degradation. In another embodiment, the system periodically suspends communication and periodically monitors the entire band 82 to test the BER, for example, at the start of a transmission. It will be recognized that digitization of the overall band, for example the overall band 82, can be performed in conjunction with a digital frequency analysis of the overall band to determine the frequency position of the interfering sources.

Referring now to FIG. 4C, once the frequency position of the interfering sources 84 is known, the system then utilizes a filter characteristic e.g. filter characteristic 86 which filters out the energy from the interfering sources to improve the BER. To provide the improved BER, the system provides an overall bandwidth 86 that is smaller than the initial overall bandwidth, e.g. the initial overall bandwidth 82 of FIG. 4.

The frequency analysis of the interfering signals 84, and the corresponding reduction in bandwidth to avoid the interfering sources 84, allows data communication even in the presence of the interfering sources 84. The bandwidth reduction avoids a problem, described above, whereby the RF/AFE front end can otherwise be saturated in the presence of the interfering sources 84. The bandwidth reduction results in the use of three bands 74-78 instead of four, (e.g. 74-80, FIG. 4A), with a corresponding 25% reduction in maximum data rate. One of ordinary skill in the art will appreciate that a reduction of data rate is often more desirable than a loss of signal integrity due to interfering sources. The continuous or periodic monitoring of the overall band also allows for resumption of the wider overall band, e.g. the overall band 82 of FIG. 4, with correspondingly increased data transmission speed when the energy of the interfering source becomes sufficiently low.

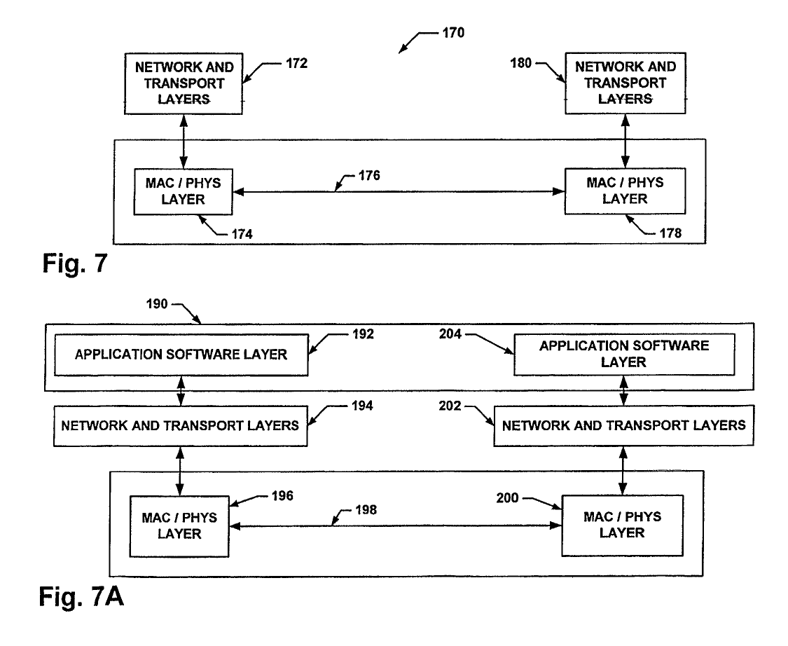

Referring now to FIGS. 5-5B, in which like elements are provided having like reference designations, charts are shown having a horizontal axis corresponding to frequency and a vertical axis corresponding to magnitude. The system can include orthogonal frequency division multiplexing (OFDM) features, known to one of ordinary skill in the art, that enable optimal frequency selection in two regards. In a first regard, as discussed above, the energy from the interfering sources is continuously or periodically monitored in order to decide where to locate the remaining bands. In a second regard, the OFDM algorithm for continuously or periodically monitors sub-carriers (e.g., sub-carriers 110 shown in FIG. 5B) having sub-carrier bit error rates (Beers), the sub-carriers within a selected band (e.g., the selected band 106). Small interfering sources (not shown) within the selected band which do not saturate the RF/AFE can then be processed using the digital functionality of the OFDM algorithm alone without programmable changes to the operation of the RF/AFE. Those skilled in the art will recognize that existing communications protocols based on OFDM, such as 802.11 (a), can be incorporated into the entire software stack of the system and can be run independently of programmable changes to the RF/AFE herein described, so long as the RF/AFE meets the protocol specifications. The software stack is further described in conjunction with FIG. 7A.

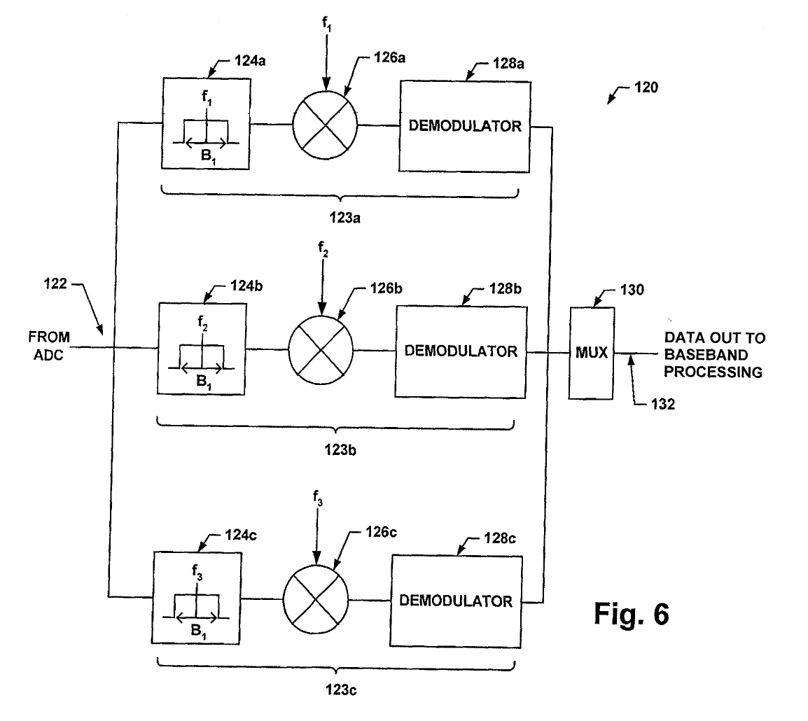

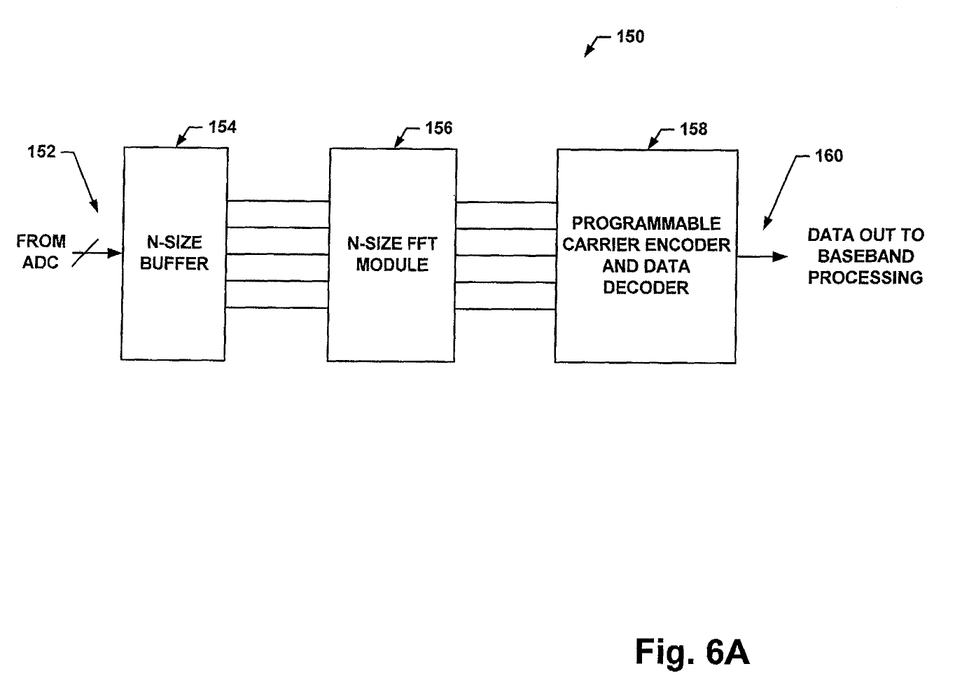

Referring now to FIG. 6, an exemplary channelizing and demodulating bank circuit 120 can be used to process a non-OFDM wideband ADC signal 122 generated by the ADC, for example the ADC 20a shown in FIG. 1. Circuit 120 is the first stage of processing of the ADC output. The exemplary circuit 120 will be understood to be circuitry provided between the ADC/DAC data converter 20 and the digital baseband and MAC layer 22 of FIG. 1. Alternatively, the circuitry 120 can be regarded as providing baseband processing and thus can be provided as part of the digital baseband and MAC layer 22 described above in conjunction with FIG. 1. The particular manner in which circuitry 120 (or the functions performed by circuitry 120) are implemented depends upon a variety of factors including but not limited to ease of implementation and the manner in which digital baseband is defined within the system. It will also be recognized by one of ordinary skill in the art that a similar circuit having a structure complimentary to the circuit 120 can be used to provide a signal to the DAC, for example the DAC portion 20b of FIG. 1. However, only the exemplary circuit 120 that receives the wideband ADC signal 122 from the ADC 20a will be described herein.

The wideband ADC signal 122 can be processed in a variety of ways. A programmable digital filter bank 124a-124N, having programmable center frequencies f₁-f_{N} and bandwidths B₁, provides a signal division into a plurality of similar parallel channels 123a-123N. While three parallel channels 123a-123N, are shown, it will be understood that any number of parallel channels 123a-123N can be provided. The number of parallel channels 123a-123N is selected in accordance with a variety of factors, including, but not limited to constraints on power consumption (e.g. battery life, etc.), the number of channels the user needs to meet bandwidth requirements and the number of channels available in the FFT snapshots of the channel. The digital filters 124a-124N are each followed by a respective programmable digital downconverter mixer 126a-126N, each having a respective programmable mixer frequency f1-fn. The digital downconverter mixers 126a-126N are each followed by a respective programmable demodulator, 128a-1287N. Outputs of the programmable demodulators 128a-128N are received by a multiplexer 130.

It will be recognized that since a multi-protocol data transmission having a variety of protocols and a variable number of associated channels is desired, the exemplary circuit 120 can also include a data buffer (not shown). The data buffer can first buffer a portion of data from the ADC, for example from the ADC 20a of FIG. 1. The data buffer can sample the data from the ADC at the ADC sample rate. Upon gathering input data in the data buffer, the data buffer can provide sets of buffered data as the input data 122 to one or more of the channels 123a-123N at a data rate higher than the ADC sampling rate. The one or more data channels 123a-123N can be selected a number of times (the number of times equal to the total number of AFE physical layer transmissions) each selection corresponding to a set of buffered data. The data channels 123a-123N can again be multiplexed together at the multiplexer 130.

Referring now to FIG. 6A, an exemplary Fast Fourier Transform (FFT) processing circuit 150 can be used to process an O/FDM wideband ADC signal 152 generated by the ADC, for example the ADC 20a shown in FIG. 1. The circuit 150 will be understood to be circuitry provided between the ADC/DAC data converter 20 and the digital baseband and MAC layer 22 of FIG. 1. or it can be provided as part of the circuit 22 in FIG. 1. It will also be recognized by one of ordinary skill in the art that a circuit similar but complimentary to the circuit 150 can be used to provide a signal to the DAC, for example the DAC portion 20b of FIG. 1. However, only the exemplary circuit 150 that receives the wideband ADC signal 122 from the ADC 20a will be described herein.

The input data 152 is provided to a data buffer. The data buffer is a memory that samples the ADC output at the ADC sample rate, each sample having a number of parallel bits N corresponding to the number of parallel bits provided by the ADC, wherein the number of parallel bits N is also referred to herein as the ADC resolution. It will be understood that the number of bits N per sample provided by the ADC is selected in accordance with the characteristics of the particular data protocol.

The buffered data is provided to a fast Fourier transform (FFT) module having a size of N, where N, as used in relation to the FFT module 156, refers to a number of output data points provided by the FFT module 156. An FFT will be recognized by one of ordinary skill in the art to provide a conversion from a time domain signal to a frequency domain signal. It will also be recognized that an FFT can be designed in a variety of ways, having a variety of sample rates and a variety of FFT output data points. The FFT sample rate and the FFT number of FFT output data points are selected in accordance with a variety of factors, including, but not limited to, the desired transmission protocols and prior knowledge (as available) of the spectral environment. The output of the FFT module 156 is a frequency vector of size N.

In one particular embodiment the clock rate of the FFT 156 is matched to that of the ADC (e.g., ADC 20a of FIG. 1), and the FFT having a number of FFT output data points corresponding to a frequency equal to the Nyquist sampling frequency where the Nyquist frequency is known to be one half of the ADC sample rate.

The output of the FFT 156 is received by a programmable carrier encoder and data decoder 158. The programmable carrier encoder and data decoder 158 synthesizes a variety of OFDM carriers (for example, up to 64 carriers within a 20 MHz bandwidth per IEEE 802.11 (a)) and then decodes the carriers to extract the symbol information encoded in the amplitudes and phases associated with the carriers. The output data 160 is provided to the digital baseband processing, for example the digital baseband and MAC layer 22 of FIG. 1.

It will be recognized that the circuitry 120 of FIG. 6 and the circuitry 150 of FIG. 6A can be provided with a variety of technologies, including, but not limited to, discrete circuits, semi-integrated circuits, fully integrated circuits, and programmable circuits. Programmable circuits include, but are not limited to general-purpose microprocessors and digital signal processors (DSPs). It will be recognized that some or all of the various blocks of FIGS. 6 and 6A can be provided by either a microprocessor or by a DSP.

Referring now to FIG. 7, a data communication 170 can include a network and transport layer 172 coupled to a MAC/physical layer 174 at a first endpoint. The MAC/physical layer 174 communicates on the coupling 176 to the MAC/physical layer 178 at a second endpoint. The MAC/physical layer 178 is coupled to a network and transport layer 180.

The invention as described herein may not require software modifications at levels above the MAC layer, for example at the network and transport layers 172, 180 depending upon the specific data protocol used. For example, in a TCP/IP enabled protocol such as 802.11, the TCP/IP transport/network layers 172, 180 are provided to accommodate wider transmission pipes as they automatically become available. The TCP/IP enabled protocol provides continuous adjustment of the number of bands throughout a communication session as channel congestion increases or decreases. Thus, for the TCP/IP enabled protocol, no modification is required to the network and transport layers 172, 180. Therefore, for this particular example, only the MAC/physical layers 174, 178 are effected by this invention.

Referring now to FIG. 7A, a data communication 190 can include an application software layer 192 coupled to a network and transport layer 194, which is coupled to a MAC/physical layer 196 at a first endpoint. The MAC/physical layer 196 communicates on the coupling 198 to the MAC/physical layer 200 at a second endpoint. The MAC/physical layer 200 is coupled to a network and transport layer 202, which is coupled to an application software layer 204.

For some protocols, it is necessary to modify the application and software layers 192, 204, and the network and transport layers 194, 202, in addition to the modifications described above to the MAC/physical layers 196, 200. The modifications are required to function with the multiple bands.

Having described preferred embodiments of the invention, it will now become apparent to one of ordinary skill in the art that other embodiments incorporating their concepts may be used. It is felt therefore that these embodiments should not be limited to disclosed embodiments, but rather should be limited only by the spirit and scope of the appended claims.

All references cited herein are hereby incorporated herein by reference in their entirety.

What is claimed is:

1. A method for providing a spectrally efficient communications channel in a communications system comprising:
analyzing a spectrum to determine a bandwidth required for transmission of data within a channel; and
allocating one or more extents within the spectrum, with each of the one or more extents being allocated as closely together as possible; and
providing a communications system having a power consumption characteristic selected to be less than a power consumption characteristic which would exist if the entire spectrum were used for transmission by the communications system.

2. The method of claim 1 wherein allocating extents within a spectrum comprises controlling power consumption of the communications system.

3. The method of claim 1 wherein controlling power consumption of the communications system comprises controlling bias currents of a data converter.

4. The method of claim 1 wherein allocating extents within a spectrum comprises controlling a filter bandwidth and power consumption of components in an RF/AFE.

5. The method of claim 1 wherein analyzing comprises using a configurable converter to examine multiple bandwidths at multiple resolution levels.

6. The method of claim 1 wherein allocating extents within a spectrum comprises at least one of: (a) controlling a data converter bandwidth to reduce power consumption; and (b) controlling a data converter resolution to reduce power consumption.

7. The method of claim 1 wherein allocating extents within a spectrum comprises controlling a center frequency of a frequency synthesizer.

8. A method for providing a communications channel in a communications system having a front end, the method comprising:
allocating multiple extents with each of the extents being allocated to minimize required bandwidth while still following one or more bandwidth limits set in a protocol specification;
selecting a filter and data conversion characteristic for the front end which encompasses each of the multiple extents and which requires reduced power consumption by the communications system; and
in response to detection of an impediment to transmission in an extent, changing the filter characteristic of the front end such that the front end is provided having a filter skirt which encompasses some of the allocated multiple extents but which excludes the extent having the impediment.

9. The method of claim 8 further comprising:
programming a data converter bank to have a bandwidth equal to the total bandwidth encompassed within the filter skirt;
setting a frequency synthesizer center frequency to a center frequency of the filter skirt; and
controlling power consumption in a filter and data converter.

10. The method of claim 8 wherein the step of allocating multiple extents of spectrum comprises allocating multiple adjacent extents of spectrum.

11. A method of providing a communication channel comprising:
allocating adjacent extents;
setting a frequency synthesizer center frequency and filter skirts such that the bandwidth operated on by a data converter is reduced in proportion to the reduction in unused bandwidth thereby reducing power consumption of the communications system to a level which is lower than the power consumption level which would be required to convert data in both the used and unused portions of the band.

12. The method of claim 11 wherein allocating adjacent extents includes dynamically programming a receiver front end to allocate adjacent extents.

13. The method of claim 11 further comprising selecting predetermined ones of a plurality of possible extents for transmission of signals throughout the band.

14. The method of claim 13 wherein selecting predetermined ones of a plurality of possible extents comprises at least one of:
transmitting on a plurality of trial bands;
monitoring a bit error rate (BER) in each of the plurality of trial bands; and
digitizing an entire band; and
selecting a band in which the RF energy already present in the channel is lowest; and
reducing power consumption by not transmitting on channels having an impediment to transmission or which are not required for data transmission.

15. The method of claim 13 wherein selecting predetermined ones of a plurality of possible extents on which to transmit throughout the band includes selecting predetermined ones of a plurality of possible extents on which to transmit throughout the band at the beginning of transmission and transmitting on only those channels which are required for data transmission thereby reducing power consumption.

16. A method comprising:
monitoring one or more extents within a band in which one or more users are transmitting;
detecting the presence of one or more interference signals within the band;
determining the location of the interference signals within the band; and
in response to determining the location of the interference signals within the band, changing the operating characteristics of one or more individual components in a radio frequency analog front end (RF/AFE) to provide the RF/AFE having a filter characteristic selected to filter out at least one of the one or more interference signals within the band and to reduce power consumption.

17. The method of claim 16 wherein the interferer signals correspond to at least one of: (1) uncoordinated communications between users; and (2) non-communications sources.

18. The method of claim 16 wherein detecting comprises at least one of: (1) monitoring a BER for an interference condition; and (2) periodically suspending communication and digitizing an entire band at the start of a transmission.

19. The method of claim 16 wherein determining the location of the interferer signals within the band comprises digitizing the entire band to enable a frequency analysis of the band to determine the location of the interference signals within the band.
